(19) United States
(12) Patent Application Publication
(10) Pub. No.: US 2010/0149124 A1
(43) Pub. Date: Jun. 17, 2010

(54) METHOD FOR IMPLEMENTING MOUSE ALGORITHM USING TACTILE SENSOR

(75) Inventors: Jong-ho Kim, Daejeon (KR); Hyun-joon Kwon, Seoul (KR); Yon-kyu Park, Daejeon (KR); Min-seok Kim, Daejeon (KR); Dae-im Kang, Daejeon (KR); Jae-hyuk Choi, Daejeon (KR)

Correspondence Address: CANTOR COLBURN, LLP, 20 Church Street, 22nd Floor, Hartford, CT, 06103, US

(73) Assignee: KOREA RESEARCH INSTITUTE OF STANDARDS AND SCIENCE, Daejeon (KR)

(21) Appl. No.: 12/667,983

(22) PCT Filed: Aug. 3, 2007
(86) PCT No.: PCT/KR07/03742

§ 371 Date: Jan. 6, 2010

(30) Foreign Application Priority Data
Jul. 6, 2007 (KR) 10-2007-0068237

(51) Int. Cl. G06F 3/041

(52) U.S. Cl. 345/173

(57) ABSTRACT

A method for implementing a mouse algorithm using a plurality of pressure sensors is disclosed. The pressure sensors are used to freely move and rotate a mouse cursor in X, Y and Z directions, so that they can be applied as interface units for a slim device such as a mobile phone. The mouse algorithm processes a touch input. The pressure sensors are arranged in a ring shape and provide output values successively varying with magnitudes of forces applied thereto or pressures applied thereto. A moving direction of the mouse cursor is determined depending on a contact point detected through the output values and a moving distance and moving speed of the mouse cursor are determined in proportion to the magnitudes of the forces.

### BACKGROUND OF THE INVENTION

1. Field of the Invention

The present invention relates to a mouse algorithm implementation method, and more particularly to a method for implementing a mouse algorithm using a plurality of pressure sensors, in which the pressure sensors are used to freely move and rotate a mouse cursor in X, Y and Z directions, so that they can be applied as interface units for a slim device such as a mobile phone.

2. Description of the Related Art

Nowadays, in computer systems, there are various types of input units that perform input operations. These operations generally correspond to selections on a display screen by the movement of a cursor, and include a page turning function, scroll function, panning function, zooming function, etc.

In general, the input units include a button, switch, keyboard, mouse, trackball, joystick, etc.

Here, the button and switch are generally mechanical, so that they have the disadvantage of being limited in being controlled to move the cursor or make selections. For example, the button or switch provides only a function of moving the cursor in a specific direction using a key such as an arrow direction key or making a specific selection using a key such as an Enter key, Delete key or number key.

On the other hand, when the user moves the mouse along the surface, an input pointer is moved corresponding to the relative movement of the mouse. Also, when the user moves the trackball within the housing, the input pointer is moved corresponding to the relative movement of the trackball.

These mouse and trackball each have one or more buttons for performing a selection function. In particular, the mouse includes a scroll wheel which can be rolled forward and backward to move the input pointer through a graphical user interface.

FIG. 7A is a perspective view of a conventional multifunctional mouse that has the input pointer moving function, selection function and scroll function based on the position recognition as stated above. This conventional multifunctional mouse requires a relatively wide mouse pad such as a desk or table. As a result, it is difficult to apply the conventional mouse using the position recognition to a mobile device, because the mobile device is limited in size.

FIG. 7B is a perspective view of a conventional joystick that manipulates the cursor using force. This conventional joystick is also so thick that it cannot be applied to a mobile device which gradually becomes slim. Also, there is a limitation in designing and developing the joystick in consideration of a GUI environment.

Therefore, there is a need to develop an input unit capable of recognizing the movements and rotations of the cursor in X, Y and Z directions through force-based pressure sensing using slimmable pressure sensors as shown in FIG. 8, and an algorithm capable of sensing such.

### SUMMARY OF THE INVENTION

Therefore, the present invention has been made in view of the above problems, and it is an object of the present invention to provide a method for implementing a mouse algorithm using a plurality of pressure sensors, the pressure sensors, in which the mouse algorithm is implemented to freely move and rotate a mouse cursor in X, Y and Z directions using the pressure sensors, so that the pressure sensors can be applied as interface units for a slim device such as a mobile phone.

In accordance with the present invention, the above and other objects can be accomplished by the provision of a method for implementing a mouse algorithm using a plurality of pressure sensors, the pressure sensors functioning as a mouse, the mouse algorithm processing a touch input of the pressure sensors, the method comprising calculating a force vector of a contact point based on a magnitude and direction of force touching the pressure sensors and sensing touch input information regarding a moving direction and moving distance of a mouse cursor based on the calculated force vector.

Preferably, the step of calculating a moving direction and moving distance of the mouse cursor comprises: obtaining force vectors ( . . . , Fᵢ, Fᵢ₊₁, . . . , Fₖ, Fₖ₊₁, . . . ) having magnitudes ( . . . , |Fᵢ|, |Fᵢ₊₁|, . . . , |Fₖ|, |Fₖ₊₁|, and X-axis angles ( . . . , θᵢ, θᵢ₊₁, . . . , θₖ, θₖ₊₁, . . . ) from a plurality of pressure sensors ( . . . , Aᵢ, Aᵢ₊₁, . . . , Aₖ, Aₖ₊₁, . . . ) around the contact point, respectively; obtaining differences ( . . . , ΔFᵢ, ΔFᵢ₊₁, . . . ) among the obtained force vectors and calculating a force vector (Fₘₐₓ) having a sum (|Fₘₐₓ|) of the magnitudes of the force vectors of the pressure sensors around the contact point and an X-axis angle (θₘₐₓ) from the obtained differences, the force vector (Fₘₐₓ) being the force vector of the contact point; and calculating the moving direction and moving distance of the mouse cursor using the calculated force vector (Fₘₐₓ) having the magnitude sum (|Fₘₐₓ|) and the X-axis angle (θₘₐₓ).

Alternatively, the step of calculating the moving direction and moving distance of the mouse cursor may comprise: finding a force vector (Fᵢ₊₁) of an (i+1)th sensor (Aᵢ₊₁) having a maximum magnitude of force, among a plurality of pressure sensors around the contact point, and force vectors (Fᵢ and Fᵢ₊₂) of an ith sensor (Aᵢ) and (i+2)th sensor (Aᵢ₊₂) located at both sides of the (i+1)th sensor (Aᵢ₊₁); calculating a force vector (Fₘₐₓ) having a sum (|Fₘₐₓ|) of magnitudes of the force vectors of the ith sensor, (i+1)th sensor and (i+2)th sensor and an X-axis angle (θₘₐₓ), the force vector (Fₘₐₓ) being the force vector of the contact point; and calculating the moving direction and moving distance of the mouse cursor using the calculated force vector (Fₘₐₓ) having the magnitude sum (|Fₘₐₓ|) and the X-axis angle (θₘₐₓ).

As another alternative, the step of calculating the moving direction and moving distance of the mouse cursor may comprise: finding a force vector (Fᵢ₊₁) of an (i+1)th sensor (Aᵢ₊₁) having a maximum magnitude of force, among a plurality of pressure sensors around the contact point, and force vectors (Fᵢ and Fᵢ₊₂) of an ith sensor (Aᵢ) and (i+2)th sensor (Aᵢ₊₂) located at both sides of the (i+1)th sensor (Aᵢ₊₁); obtaining a magnitude distribution function F(θ)=aθ+a₁θ+a₂θ² by fitting force magnitudes of the ith sensor, (i+1)th sensor and (i+2)th sensor to a quadratic curve; obtaining an X-axis angle (θₘₐₓ) where the maximum force magnitude is present; obtaining a force vector (Fₘₐₓ) having a maximum magnitude |Fₘₐₓ| at the angle (θₘₐₓ) from the magnitude distribution function, the force vector (Fₘₐₓ) being the force vector of the contact point; and calculating the moving distance and direction of the mouse cursor using the obtained force vector (Fₘₐₓ) having the magnitude (|Fₘₐₓ|) and the X-axis angle (θₘₐₓ).

The step of calculating the moving direction and moving distance of the mouse cursor may comprise calculating the moving distance of the mouse cursor based on the magnitude sum or maximum magnitude (|Fₘₐₓ|) and calculating the moving direction of the mouse cursor based on the X-axis angle (θₘₐₓ), or calculating the moving distance of the mouse cursor based on |Fₘₐₓ|cosθₘₐₓ+|Fₘₐₓ|sinθₘₐₓ which is a sum of an X component magnitude and a Y component magnitude of the force vector (Fₘₐₓ) and calculating the moving direction of the mouse cursor based on the X-axis angle (θₘₐₓ).

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B are views illustrating a method for implementing a mouse algorithm using a plurality of pressure sensors according to a first embodiment of the present invention;

FIGS. 2A and 2B are views illustrating a method for implementing a mouse algorithm using a plurality of pressure sensors according to a second embodiment of the present invention;

FIG. 3 is a view illustrating a method for implementing a mouse algorithm using a plurality of pressure sensors according to a third embodiment of the present invention;

FIGS. 4A and 4B are views illustrating a method for implementing a mouse algorithm using a plurality of pressure sensors according to a fourth embodiment of the present invention;

FIG. 5 is a view illustrating a method for implementing a mouse algorithm using a plurality of pressure sensors according to a fifth embodiment of the present invention;

FIG. 6 is a view illustrating a method for implementing a mouse algorithm using a plurality of pressure sensors according to a sixth embodiment of the present invention;

FIG. 7A is a perspective view of a conventional multifunctional mouse;

FIG. 7B is a perspective view of a conventional joystick;

FIG. 8 is a view showing an X, Y and Z-movable and rotatable slim mouse using a plurality of pressure sensors including a plurality of force sensors according to the present invention;

FIG. 9A is a view showing the plurality of pressure sensors according to the fifth embodiment of the present invention; and

FIG. 9B is a view showing a slim mouse for a mobile phone using the plurality of pressure sensors according to the fifth embodiment of the present invention.

### DETAILED DESCRIPTION OF THE PREFERRED EMBODIMENTS

The present invention provides a method for implementing an algorithm for processing a touch input of a plurality of pressure sensors including a plurality of force sensors. This algorithm is implemented to calculate a force vector of a contact point based on the magnitude and direction of force touching the pressure sensors and sense touch input information regarding the moving distance and direction of a mouse cursor based on the calculated force vector.

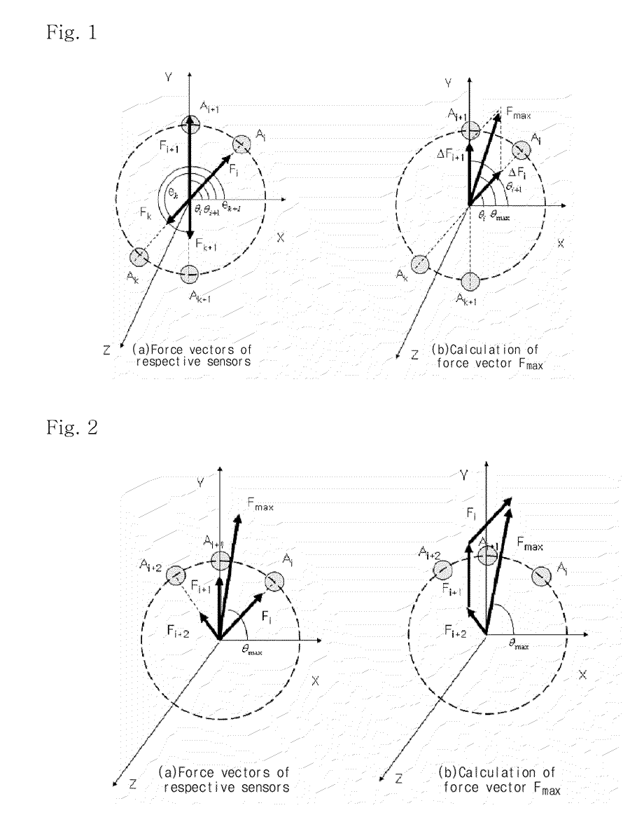

FIGS. 1 to 3 are views illustrating methods for implementing mouse algorithms using pressure sensors, more particularly methods for implementing mouse algorithms of unit cell pressure sensors according to first to third embodiments of the present invention, respectively. A force vector of a contact point can be calculated based on the magnitude of force in the following manner.

The first embodiment of the present invention will hereinafter be described with reference to FIGS. 1A and 1B. First, as shown in FIG. 1A, force vectors Fᵢ, Fᵢ₊₁, Fₖ and Fₖ₊₁ having magnitudes |Fᵢ|, |Fᵢ₊₁|, |Fₖ| and |Fₖ₊₁| and X-axis angles θᵢ, θᵢ₊₁, θₖ and θₖ₊₁are obtained from arbitrary sensors Aᵢ, Aᵢ₊₁, Aₖ and Aₖ₊₁ representing the outputs of force, among the plurality of pressure sensors, respectively.

Then, the X-axis angles θᵢ and θᵢ₊₁ and magnitudes |Fᵢ−Fₖ| and |Fᵢ₊₁−Fₖ₊₁| of force vectors ΔFᵢ and ΔFᵢ₊₁ are calculated using the force vectors Fᵢ, Fₖ, Fᵢ₊₁ and Fₖ₊₁, as shown in FIG. 1B.

Then, a force vector Fₘₐₓ of the contact point having an X-axis angle θₘₐₓ and a magnitude |Fₘₐₓ| is calculated using the X-axis angles θᵢ and θᵢ₊₁ and magnitudes |Fᵢ−Fₖ| and |Fᵢ₊₁−Fₖ₊₁| of the vectors ΔFᵢ and ΔFᵢ₊₁, and the moving distance and direction of a mouse cursor are sensed from the calculated force vector Fₘₐₓ.

Here, the moving distance of the mouse cursor may be calculated based on the magnitude |Fₘₐₓ| and the moving direction of the mouse cursor may be calculated based on the X-axis angle θₘₐₓ, or the magnitude |Fₘₐₓ| may be defined as |Fₘₐₓ|cosθₘₐₓ+|Fₘₐₓ|sinθₘₐₓ which is the sum of an X component magnitude and a Y component magnitude of the force vector Fₘₐₓ. This means that the mouse cursor can be moved in a rotation direction by adjusting the moving distance of the mouse cursor in X and Y directions.

The second embodiment of the present invention will hereinafter be described with reference to FIGS. 2A and 2B. First, a force vector Fᵢ₊₁ of an (i+1)th sensor Aᵢ₊₁ having a maximum magnitude of force, among a plurality of pressure sensors around the contact point, and force vectors Fᵢ and Fᵢ₊₂ of an ith sensor Aᵢ and (i+2)th sensor Aᵢ₊₂ located at both sides of the (i+1)th sensor Aᵢ₊₁ are found as shown in FIG. 2A.

Then, a force vector Fₘₐₓ having the sum |Fₘₐₓ| of the magnitudes of the force vectors Fᵢ₊₁, Fᵢ and Fᵢ₊₂ of the (i+1)th sensor Aᵢ₊₁, ith sensor Aᵢ and (i+2)th sensor Aᵢ₊₂ and an X-axis angle θₘₐₓ is calculated as shown in FIG. 2B.

Then, the moving distance and direction of a mouse cursor are calculated using the force vector Fₘₐₓ. Here, the moving distance of the mouse cursor may be calculated based on the magnitude sum |Fₘₐₓ| and the moving direction of the mouse cursor may be calculated based on the X-axis angle θₘₐₓ, or the magnitude sum |Fₘₐₓ| may be defined as |Fₘₐₓ|cosθₘₐₓ+|Fₘₐₓ|sinθₘₐₓ which is the sum of an X component magnitude and a Y component magnitude of the force vector Fₘₐₓ. This means that the mouse cursor can be moved in a rotation direction by adjusting the moving distance of the mouse cursor in X and Y directions.

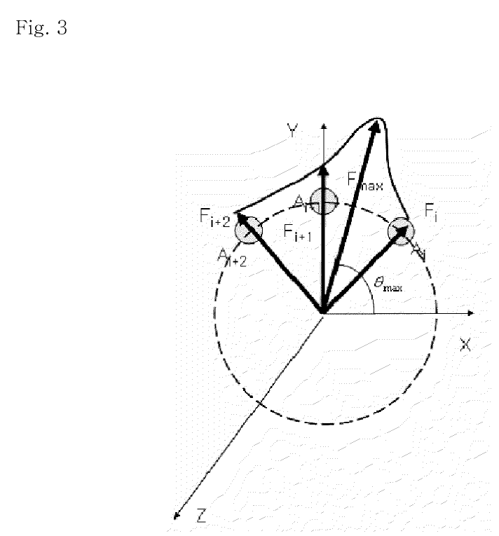

Referring to FIG. 3, in the third embodiment of the present invention, a force vector Fᵢ₊₁ of an (i+1)th sensor Aᵢ₊₁ having a maximum magnitude of force, among a plurality of pressure sensors around the contact point, and force vectors Fᵢ and Fᵢ₊₂ of an ith sensor Aᵢ and (i+2)th sensor Aᵢ₊₂ located at both sides of the (i+1)th sensor Aᵢ₊₁ are found.

Then, a magnitude distribution function F(θ)=aθ+a₁θ+a₂θ² is obtained by fitting force magnitudes |Fᵢ|, |Fᵢ₊₁| and |Fᵢ₊₂| corresponding respectively to the coordinates of the ith sensor Aᵢ, (i+1)th sensor Aᵢ₊₁ and (i+2)th sensor Aᵢ₊₂ to a quadratic curve.

Then, an X-axis angle θₘₐₓ where the maximum force magnitude is present is obtained, a force vector Fₘₐₓ having a maximum magnitude |Fₘₐₓ| at the angle θₘₐₓ is obtained from the magnitude distribution function, and the moving distance and direction of a mouse cursor are calculated using the obtained force vector Fₘₐₓ.

Here, the moving distance of the mouse cursor may be calculated based on the magnitude |Fₘₐₓ| or |Fₘₐₓ|cosθₘₐₓ+|Fₘₐₓ|sinθₘₐₓ which is the sum of an X component magnitude and a Y component magnitude of the force vector Fₘₐₓ, and the moving direction of the mouse cursor may be calculated based on the angle θₘₐₓ. This means that the mouse cursor can be moved in a rotation direction by adjusting the moving distance of the mouse cursor in X and Y directions.

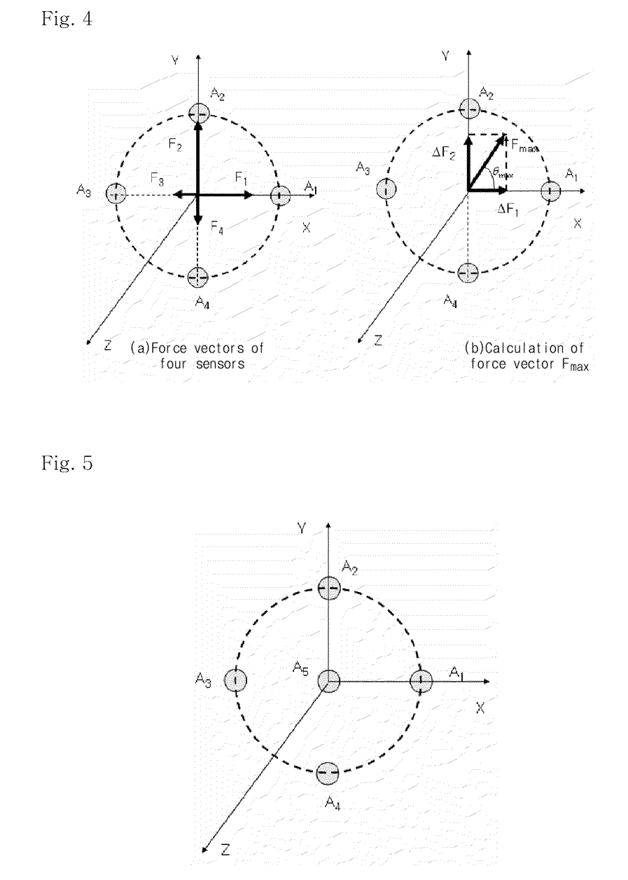

FIGS. 4A and 4B are views illustrating a method for implementing a mouse algorithm using a plurality of pressure sensors according to a fourth embodiment of the present invention. Referring to FIG. 4A, the pressure sensors used in the fourth embodiment of the present invention includes four sensors A₁, A₂, A₃ and A₄. A force vector of a contact point can be calculated based on the magnitude of force in the following manner.

The four sensors A₁, A₂, A₃ and A₄ have the following force vectors: the first sensor has F₁, the second sensor F₂, the third sensor F₃, and the fourth sensor F₄. In the present embodiment, the force vector F₂ of the second sensor A₂ has a maximum magnitude and the force vector F₁ of the first sensor A₁ has a lesser magnitude.

Then, referring to FIG. 4B, the magnitudes |F₁−F₃| and |F₂−F₄| of force vectors ΔF₁ and ΔF₂ are calculated. Here, the force vector ΔF₁ has an angle of 0° and the force vector ΔF₂ has an angle of 90°.

Then, the X-axis angle θₘₐₓ and magnitude |Fₘₐₓ| of a force vector Fₘₐₓ are calculated using the angles 0° and 90° and magnitudes |F₁−F₃| and |F₂−F₄| of the vectors ΔF₁ and ΔF₂.

Here, the magnitude |Fₘₐₓ| is defined as |ΔF₁|+|ΔF₂| or \sqrt{|ΔF₁|²+|ΔF₂|²}.

Also,

$${θ}_{max} = {tan}^{- 1} ( \frac{\vert {F}_{2} - {F}_{4} \vert}{\vert {F}_{1} - {F}_{3} \vert} ) .$$

The direction and magnitude components of force of the contact point are obtained using the X-axis angle θₘₐₓ and magnitude |Fₘₐₓ|.

Here, the X direction component of the contact point is |F₁−F₃|, which is an X component of the force vector Fₘₐₓ, and the Y direction component of the contact point is |F₂−F₄|, which is a Y component of the force vector Fₘₐₓ. As a result, the moving distance of a mouse cursor in an X direction is |F₁−F₃| which is the X component of the force vector Fₘₐₓ, and the moving distance of the mouse cursor in a Y direction is |F₂−F₄| which is the Y component of the force vector Fₘₐₓ.

On the other hand, the moving distance of the mouse cursor in a Z direction using the four sensors can be expressed by the average of the sum of the magnitudes of the force vectors of the four sensors. Here, the Z direction movement is established only in one side direction.

In the first to fourth embodiments of the present invention, the movements and rotations of the mouse cursor in the X, Y and Z directions are sensed through successive contact sensing of the pressure sensors. In the case where the magnitude of force detected from at least one of the plurality of pressure sensors is in the form of an impulse signal or a Z direction magnitude detected therefrom is larger than or equal to a reference value, the current operation is recognized as a click.

The addition of the click recognition function as stated above makes it possible to open or close a file on the screen using the pressure sensors, like using a mouse in an existing computer.

Alternatively, as shown in FIG. 5, in addition to the four force sensors A₁, A₂, A₃ and A₄, a fifth sensor A₅ may be installed at the center of the pressure sensors so as to be utilized as a clock recognition unit.

For example, when a contact on the fifth sensor A₅ is sensed, it can be recognized as a click to open or close a file on the screen. Meanwhile, when the fifth sensor A₅ is clicked and any one of the second and fourth sensors A₂ and A₄ is then pushed, scrolling can be performed in a direction set by the pushed sensor.

Also, in the case where the mouse cursor is required to be moved in a three-dimensional space, the mouse cursor is moved in the X and Y directions using the four force sensors as shown in FIG. 4 and the Z direction moving distance of the mouse cursor is defined by the magnitude of a force vector of the fifth sensor. Here, the Z direction movement is established only in one side direction.

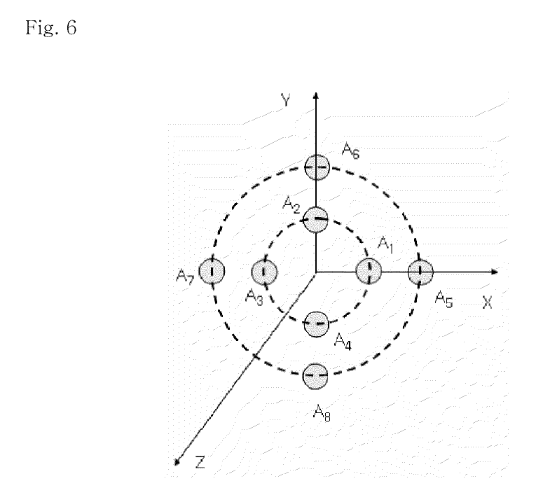

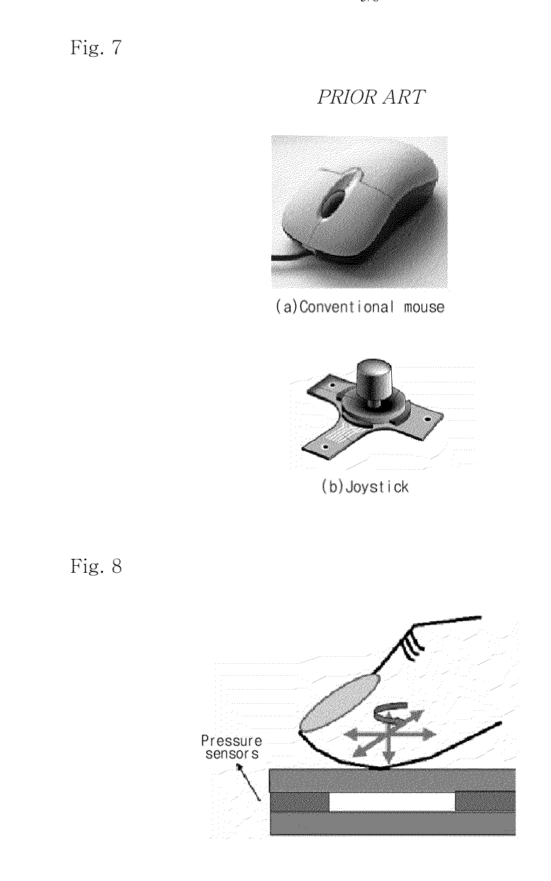

As another alternative, as shown in FIG. 6, the mouse cursor may be moved in the X, Y and Z directions and the rotation direction using a plurality of pressure sensors including the four force sensors A₁, A₂, A₃ and A₄, and four sensors A₅, A₆, A₇ and A₈ located at the outside of the sensors A₁, A₂, A₃ and A₄. In this case, the click and scroll functions can be performed as in the existing mouse.

The first to fourth A₁, A₂, A₃ and A₄ can be used to move the mouse cursor in the X and Y directions and the rotation direction, as shown in FIG. 5. The one-side Z direction movement and moving distance of the mouse cursor are determined based on the direction and magnitude of a force vector of the sixth sensor A₆, and the other-side Z direction movement and moving distance of the mouse cursor are determined based on the direction and magnitude of a force vector of the eighth sensor A₈.

On the other hand, the click function and scroll function can be carried out while the cursor is moved on an X-Y plane, as in the existing mouse. That is, the click function is assigned to any one of the fifth to eighth sensors A₅, A₆, A₇ and A₈, and performed when a contact on the assigned sensor is sensed. Therefore, it is possible to open or close a file on the screen through the click recognition, as in the existing mouse.

Alternatively, a specific one of the fifth to eighth sensors A₅, A₆, A₇ and A₈ may be set as a click recognition sensor. In this case, the click function is performed when a contact on the specific sensor is sensed, and the scroll function is performed when contacts on the other sensors are sensed. For example, in the case where the fifth sensor A₅ and seventh sensor A₇ are set for the click recognition, the scroll function of the existing mouse can be performed using the sixth sensor A₆ and eighth sensor A₈.

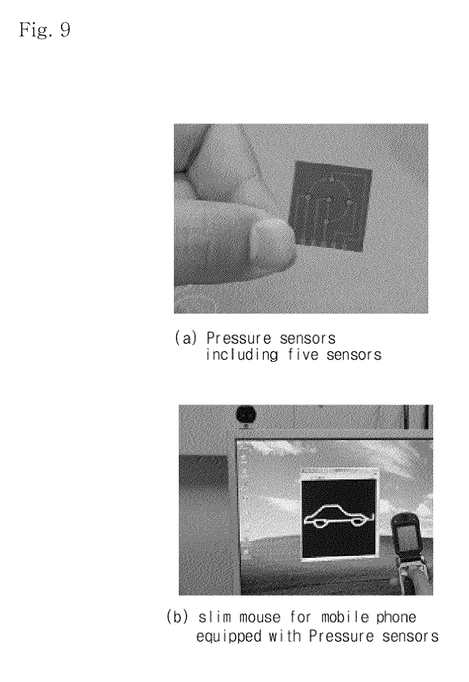

FIG. 9A shows a plurality of pressure sensors made using four sensors A₁, A₂, A₃ and A₄ and a fifth sensor A₅ located at the center thereof. FIG. 9B shows a slim mouse for a mobile phone using the pressure sensors.

When a contact on the fifth sensor A₅ is sensed, it can be recognized as a click to open or close a file on the screen. Meanwhile, when the fifth sensor A₅ is clicked and any one of the second and fourth sensors A₂ and A₄ is then pushed, scrolling can be performed in a direction set by the pushed sensor.

As apparent from the above description, according to the present invention, a mouse algorithm is implemented to freely move and rotate a mouse cursor in X, Y and Z directions using a plurality of pressure sensors, so that the pressure sensors can be applied as an interface unit for a slim device such as a mobile phone. Therefore, the pressure sensors can replace an existing mouse or joystick so as to be applied to a GUI environment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. (canceled)

2. A method for implementing a mouse algorithm using a plurality of pressure sensors, the mouse algorithm processing a touch input the pressure sensors being arranged in a ring shape and providing output values successively varying with magnitudes of forces applied thereto or pressures applied thereto, wherein a moving direction of a mouse cursor is determined depending on a contact point detected through the output values and a moving distance and moving speed of the mouse cursor are determined in proportion to the magnitudes of the forces, the method comprising calculating the moving direction and moving distance of the mouse cursor,
wherein the step of calculating the moving direction and moving distance of the mouse cursor comprises:
obtaining force vectors ( . . . , Fᵢ, Fᵢ₊₁, . . . , Fₖ, Fₖ₊₁, . . . ) having magnitudes ( . . . , |Fᵢ|, |Fᵢ₊₁|, . . . , |Fₖ|, |Fₖ₊₁|, . . . ) and X-axis angles ( . . . , θᵢ, θᵢ₊₁, . . . , θₖ, θₖ₊₁, . . . ) from pressure sensors ( . . . , Aᵢ, Aᵢ₊₁, . . . , Aₖ, Aₖ₊₁, . . . ) around the contact point, respectively;
obtaining differences ( . . . , ΔFᵢ, ΔFᵢ₊₁, . . . ) among the obtained force vectors and calculating a force vector (Fₘₐₓ) having a sum (|Fₘₐₓ|) of the magnitudes of the force vectors of the pressure sensors around the contact point and an X-axis angle (θₘₐₓ) from the obtained differences; and
calculating the moving direction and moving distance of the mouse cursor using the calculated force vector (Fₘₐₓ) having the magnitude sum (|Fₘₐₓ|) and the X-axis angle (θₘₐₓ).

3. A method for implementing a mouse algorithm using a plurality of pressure sensors, the mouse algorithm processing a touch input, the pressure sensors being arranged in a ring shape and providing output values successively varying with magnitudes of forces applied thereto or pressures applied thereto, wherein a moving direction of a mouse cursor is determined depending on a contact point detected through the output values and a moving distance and moving speed of the mouse cursor are determined in proportion to the magnitudes of the forces, the method comprising calculating the moving direction and moving distance of the mouse cursor,
wherein the step of calculating the moving direction and moving distance of the mouse cursor comprises:
finding a force vector (Fᵢ₊₁) of an (i+1)th sensor (Aᵢ₊₁) having a maximum magnitude of force, among pressure sensors around the contact point, and force vectors (Fᵢ and Fᵢ₊₂) of an ith sensor (Aᵢ) and (i+2)th sensor (Aᵢ₊₂) located at both sides of the (i+1)th sensor (Aᵢ₊₁);
calculating a force vector (Fₘₐₓ) having a sum (|Fₘₐₓ|) of magnitudes of the force vectors of the ith sensor, (i+1)th sensor and (i+2)th sensor and an X-axis angle (θₘₐₓ); and
calculating the moving direction and moving distance of the mouse cursor using the calculated force vector (Fₘₐₓ) having the magnitude sum (|Fₘₐₓ|) and the X-axis angle (θₘₐₓ).

4. A method for implementing a mouse algorithm using a plurality of pressure sensors, the mouse algorithm processing a touch input, the pressure sensors being arranged in a ring shape and providing output values successively varying with magnitudes of forces applied thereto or pressures applied thereto, wherein a moving direction of a mouse cursor is determined depending on a contact point detected through the output values and a moving distance and moving speed of the mouse cursor are determined in proportion to the magnitudes of the forces, the method comprising calculating the moving direction and moving distance of the mouse cursor,
wherein the step of calculating the moving direction and moving distance of the mouse cursor comprises:
finding a force vector (Fᵢ₊₁) of an (i+1)th sensor (Aᵢ₊₁) having a maximum magnitude of force, among pressure sensors around the contact point, and force vectors (Fᵢ and Fᵢ₊₂) of an ith sensor (Aᵢ) and (i+2)th sensor (Aᵢ₊₂) located at both sides of the (i+1)th sensor (Aᵢ₊₁);
obtaining a magnitude distribution function F(θ)=aθ+a₁θ+a₂θ² by fitting force magnitudes of the ith sensor, (i+1)th sensor and (i+2)th sensor to a quadratic curve;
obtaining an X-axis angle (θₘₐₓ) where the maximum force magnitude is present;
obtaining a force vector (Fₘₐₓ) having a maximum magnitude |Fₘₐₓ| at the angle (θₘₐₓ) from the magnitude distribution function; and
calculating the moving direction and moving distance of the mouse cursor using the obtained force vector (Fₘₐₓ) having the magnitude (|Fₘₐₓ|) and the X-axis angle (θₘₐₓ).

5. The method according to claim 2, wherein the step of calculating the moving direction and moving distance of the mouse cursor comprises calculating the moving distance of the mouse cursor based on the magnitude sum or maximum magnitude (|Fₘₐₓ|) and calculating the moving direction of the mouse cursor based on the X-axis angle (θₘₐₓ), or calculating the moving distance of the mouse cursor based on |Fₘₐₓ|cosθₘₐₓ+|Fₘₐₓ|sinθₘₐₓ which is a sum of an X component magnitude and a Y component magnitude of the force vector (Fₘₐₓ) and calculating the moving direction of the mouse cursor based on the X-axis angle (θₘₐₓ).

6. The method according to claim 5, wherein a successive trajectory movement of the mouse cursor is made in various directions through detection of the moving distance and moving direction by the plurality of pressure sensors.

7. (canceled)

8. The method according to claim 5, further comprising:
additionally providing a click recognition sensor at a center of the plurality of pressure sensor and setting the plurality of pressure sensors as up, down, left and right and rotation direction selection sensors;
if a contact on the click recognition sensor is sensed, recognizing the contact as a click and then opening or closing a file;
if the contact on the click recognition sensor is sensed and a contact on any one of the direction selection sensors is then sensed, performing scrolling in a direction set by the contact-sensed direction selection sensor; and
moving the mouse cursor in a Z direction using a force vector of the click recognition sensor.

9. The method according to claim 6, further comprising:
additionally providing, at the outside of the plurality of pressure sensors, a plurality of pressure sensors;
setting any one of the additionally provided pressure sensors as a first Z direction sensor to detect a first Z direction movement of the mouse cursor; and
setting another one of the additionally provided pressure sensors facing the first Z direction sensor as a second Z direction sensor to detect a second Z direction movement of the mouse cursor.

10. The method according to claim 6, further comprising:
additionally providing, at the outside of the plurality of pressure sensors, a plurality of pressure sensors; and
performing a click function to open or close a file on a screen, if a contact on at least one of the additionally provided pressure sensors is sensed.

11. The method according to claim 6, further comprising:
additionally providing, at the outside of the plurality of pressure sensors, a plurality of pressure sensors; and
setting a specific one of the additionally provided pressure sensors as a click recognition sensor, performing a click function if a contact on the specific sensor is sensed, and performing a scroll function if contacts on the other sensors are sensed.

12. The method according to claim 3, wherein the step of calculating the moving direction and moving distance of the mouse cursor comprises calculating the moving distance of the mouse cursor based on the magnitude sum or maximum magnitude (|Fₘₐₓ|) and calculating the moving direction of the mouse cursor based on the X-axis angle (θₘₐₓ), or calculating the moving distance of the mouse cursor based on |Fₘₐₓ|cosθₘₐₓ+|Fₘₐₓ|sinθₘₐₓ which is a sum of an X component magnitude and a Y component magnitude of the force vector (Fₘₐₓ) and calculating the moving direction of the mouse cursor based on the X-axis angle (θₘₐₓ).

13. The method according to claim 4, wherein the step of calculating the moving direction and moving distance of the mouse cursor comprises calculating the moving distance of the mouse cursor based on the magnitude sum or maximum magnitude (|Fₘₐₓ|) and calculating the moving direction of the mouse cursor based on the X-axis angle (θₘₐₓ), or calculating the moving distance of the mouse cursor based on |Fₘₐₓ|cosθₘₐₓ+|Fₘₐₓ|sinθₘₐₓ which is a sum of an X component magnitude and a Y component magnitude of the force vector (Fₘₐₓ) and calculating the moving direction of the mouse cursor based on the X-axis angle (θₘₐₓ).

14. The method according to claim 12, wherein a successive trajectory movement of the mouse cursor is made in various directions through detection of the moving distance and moving direction by the plurality of pressure sensors.

15. The method according to claim 13, wherein a successive trajectory movement of the mouse cursor is made in various directions through detection of the moving distance and moving direction by the plurality of pressure sensors.

16. The method according to claim 12, further comprising:
additionally providing a click recognition sensor at a center of the plurality of pressure sensors and setting the plurality of pressure sensors as up, down, left and right and rotation direction selection sensors;
if a contact on the click recognition sensor is sensed, recognizing the contact as a click and then opening or closing a file;
if the contact on the click recognition sensor is sensed and a contact on any one of the direction selection sensors is then sensed, performing scrolling in a direction set by the contact-sensed direction selection sensor; and
moving the mouse cursor in a Z direction using a force vector of the click recognition sensor.

17. The method according to claim 13, further comprising:
additionally providing a click recognition sensor at a center of the plurality of pressure sensors and setting the plurality of pressure sensors as up, down, left and right and rotation direction selection sensors;
if a contact on the click recognition sensor is sensed, recognizing the contact as a click and then opening or closing a file;
if the contact on the click recognition sensor is sensed and a contact on any one of the direction selection sensors is then sensed, performing scrolling in a direction set by the contact-sensed direction selection sensor; and
moving the mouse cursor in a Z direction using a force vector of the click recognition sensor.

18. The method according to claim 14, further comprising:
additionally providing, at the outside of the plurality of pressure sensors, a plurality of pressure sensors;
setting any one of the additionally provided pressure sensors as a first Z direction sensor to detect a first Z direction movement of the mouse cursor; and
setting another one of the additionally provided pressure sensors facing the first Z direction sensor as a second Z direction sensor to detect a second Z direction movement of the mouse cursor.

19. The method according to claim 15, further comprising:
additionally providing, at the outside of the plurality of pressure sensors, a plurality of pressure sensors;
setting any one of the additionally provided pressure sensors as a first Z direction sensor to detect a first Z direction movement of the mouse cursor; and
setting another one of the additionally provided pressure sensors facing the first Z direction sensor as a second Z direction sensor to detect a second Z direction movement of the mouse cursor.

20. The method according to claim 14, further comprising:
additionally providing, at the outside of the plurality of pressure sensors, a plurality of pressure sensors; and
performing a click function to open or close a file on a screen, if a contact on at least one of the additionally provided pressure sensors is sensed.

21. The method according to claim 15, further comprising:
additionally providing, at the outside of the plurality of pressure sensors, a plurality of pressure sensors; and
performing a click function to open or close a file on a screen, if a contact on at least one of the additionally provided pressure sensors is sensed.

22. The method according to claim 14, further comprising:
additionally providing, at the outside of the plurality of pressure sensors, a plurality of pressure sensors; and
setting a specific one of the additionally provided pressure sensors as a click recognition sensor, performing a click function if a contact on the specific sensor is sensed, and performing a scroll function if contacts on the other sensors are sensed.

23. The method according to claim 15, further comprising:
additionally providing, at the outside of the plurality of pressure sensors, a plurality of pressure sensors; and
setting a specific one of the additionally provided pressure sensors as a click recognition sensor, performing a click function if a contact on the specific sensor is sensed, and performing a scroll function if contacts on the other sensors are sensed.
